(19) United States
(12) Patent Application Publication
(10) Pub. No.: US 2006/0136181 A1
(43) Pub. Date: Jun. 22, 2006

(54) Method and system for optimising at least one parameter characteristic of a physical system that is to be subjected to variable external conditions

(76) Inventor: John Masse, (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/031,728

(22) Filed: Dec. 22, 2004

(51) Int. Cl. G06F 17/10

(52) U.S. Cl. 703/2

(57) ABSTRACT

The present invention relates to a method for optimizing at least one parameter characteristic of a physical system, in which the model of the said system is constructed, the system being simulated in the form of a block diagram using simulation software, then the derivatives of the required variables are calculated with respect to the parameter. The result is the differentiated diagram of the system in the same simulation software, and the results are used in optimization software.

The invention relates firstly to a method for optimizing at least one parameter characteristic of a physical system that is to be subjected to variable external conditions.

When in the presence of a system, it is usually necessary to optimize, identify and analyze the sensitivity of system parameters.

A system means a set of elements forming a more or less structured assembly and fulfilling a function. There are all types of physical systems, including mechanical, biological, electrical, chemical systems, etc. A system encompasses the elements that it is decided to include in it. For example, a system may be composed of an entire car, or just the chassis and shock absorbers.

Once a system has been defined, the next step is usually to study it. This is done by modeling it, in other words designing a model representing it. The model then consists of all equations and relations used to represent and study the system. With the model, a problem can be solved in a different scientific branch; for example, a mechanical problem can be solved by defining the mathematical model that represents it and then solving this model using mathematical methods. Variables and parameters appear in equations and relations of the model.

Variables represent physical magnitudes that can vary in time and may or may not influence the system. For example, input variables could be considered, in other words magnitudes for which the effect on the system will be observed. Other variables are output variables, in other words magnitudes resulting from the reaction of the system to inputs. Another variable is time. For example, there is the example of a system composed solely of a spring characterized by its stiffness constant k, and an object with mass m is attached to the end of the spring. It may be required to study the result of an initial displacement of mass m on the system. The output variable (position of the object) is then considered as a function of the time variable.

Parameters are magnitudes that a priori remain fixed in time during operation of the system, in a given system configuration. For example, in the case of the spring described above, the mass m of the object and the stiffness constant k of the spring are magnitudes fixed before the system is studied, by the choice of the object and the spring. However, the value of these parameters will have an influence on the system behavior.

To clearly understand this concept of variable and parameter, we could describe a car road holding system. For example, this system can be defined using the vehicle speed and the elevation of the bottom of the wheels as variables; it can clearly be seen that these variables will vary in time when the car moves forwards. Parameters to be chosen could be the distance between the front and rear wheel axles, the length of these axles, the tire inflation; these parameters will not vary during the system study time (a few minutes) but will be fixed in advance; however, they will have an influence on the behavior of the car. Therefore, it can be seen that the variables will behave differently, depending on the choice of the parameters. In particular, if two studies of the system are carried out at the same speed, the elevation of the wheel will not be the same depending on the chosen parameters.

The advantage of modeling is to be able to set parameters for a system, in other words to define its parameters as a function of some requirements, or certain criteria. For example, it may be required to set parameters for the shock absorbers of a car such that the shock absorber clearance within a given range of constraints is minimum. With reference to the above example, it would also be possible to set parameters for the distance between the front and back wheel axles, the length of these axles and the tire inflation so that the elevation of the bottom of the wheels varies as little as possible. In general, a “cost” function is defined that is to be minimized. For example, in this case the cost function would be the movement distance of the shock absorbers in the first case, and the variation of the elevation of the wheels in the second case. Let us return to the simple example of the spring. We might start with a fixed mass and wish to set parameters for the spring, in other words define the value of k such that the spring, after the object has been moved and released, oscillates for the shortest possible time.

We then talk about optimization. Optimization of a system consists of finding the best compromise, in other words the best combination between system parameters in order to obtain the best results with regard to an objective and constraints. The objective may be to minimize a cost function, maximize a speed, etc.

The system can be optimized by using software means. The software usually needs mathematical derivatives of system output variables as a function of parameters, since these derivatives are used to determine the influence of a parameter on the system. In particular, it is known that a function is minimum or maximum when its derivative is zero.

In automation, it frequently happens that a system is represented by a “block diagram”. It is then said that it is modeled in the form of a block diagram. In general, a block diagram is a diagram composed of blocks (rectangles, triangles, etc.), connected to each other by lines, the blocks and lines having a particular meaning and function depending on what is being represented by the block diagram. In automation, each line carries a variable (input, output or intermediate variable) of the system. When the variables pass into a block, which contains a function, the function applied to the variables is obtained at the output and therefore on the line at the output from the block (if it is a transfer function, this function multiplied by variables is obtained at the output).

CAD (Computer Aided Design) software is used in automation, like the Simulink trademark, that models and simulates systems by means of block diagrams. The system equations and relations are input, and the software outputs the corresponding block diagram. It is also capable of producing output curves as a function of time, simulating the system behavior.

However, as we have already seen, when it is required to optimize, identify and make a sensitivity analysis, etc., it is often necessary to know the derivative of the model with respect to the parameters. The first derivative and even second derivative is often necessary for optimization algorithms.

Two solutions are currently available to an engineer to calculate this derivative. The first consists of literally writing the system of equations and then formally integrating it when there is an analytic solution (which is usually not the case) and finally differentiating the solution obtained with respect to the parameter that has been chosen. However, this approach is long and difficult and does not necessarily produce a result. Moreover, the system has to be reduced since only analytic functions, can be formally differentiated, and therefore not logical and hysteresis functions although these functions are widespread in industrial problems.

A second method is to calculate the derivative digitally by finite differences. This is the most frequently used method. If k is the chosen parameter, and if it is desired to know the so-called straight derivative, then (ƒ(k+ε)−ƒ(k))/ε, which is called the rate of increase, is calculated. This technique requires many tests in order to fix the right value of the increment ε of the parameter k, and there is no guarantee that a good approximation of the true derivative will be obtained. In particular, if ε is too large or too small, the derivative will be wrong. Moreover, if there are several parameters, then ε will have to be adapted to each parameter. Finally, in the case of hybrid functions (in other words for example discontinuous, discrete, sampled, logical functions, etc.), there may be transition problems (function non-continuity), in which the derivative will be infinite; there will then be a bad derivative with the presence of noise, making it impossible to obtain the best result. All this is true for the first derivative and is even more true for higher order derivatives. In any case, these higher orders are practically impossible to calculate digitally.

This invention is intended to overcome these disadvantages.

Consequently, this invention relates to a method for optimizing at least one parameter characteristic of a physical system that is to be subjected to variable external conditions, in which the system is modeled in the form of a block diagram comprising at least one input variable, at least one output variable and at least one function block between the input and output variables, and in which a differentiated block diagram is constructed from said block diagram, comprising a differentiated block with the input variable and its derivative with respect to the parameter as input, and the derivative of the output variable with respect to the parameter as output.

According to another characteristic, the differentiated block diagram is constructed including, as output, the output variable and its derivative with respect to the parameter.

Preferably, if the function block itself is composed of several function blocks, then each block is differentiated according to the method of this invention independently, considering, for each differentiation, the input and output variables of the block being differentiated.

Preferably again, the input variable and its derivative with respect to the parameter are arranged in vectorial form, in other words these are vectors of several variables.

According to another characteristic, if the output variable depends on several parameters, a differentiated block diagram is constructed from the block diagram such that when the input variable and its derivatives with respect to each parameter are input into the new block diagram, the derivatives of the output variable with respect to each parameter are obtained as output.

According to another characteristic, if neither the input variable nor the block depend on the parameter, the value of the derivative of the output variable with respect to the parameter is set equal to the value zero without calculation.

This invention enables automatic generation of partial derivatives with respect to the parameters of a model, with the initial model and its differentiated model being described in the same block diagram simulation environment. Thus, the differentiated model will be analyzed in the same simulation environment.

The block diagram includes variable flows and their differentiated flows. The behavior of the differentiated block diagram is analyzed in the same way as for the initial block diagram. Therefore, in particular, the initial models and differentiated models can be analyzed at the same time.

Once the differentiated model has been generated, it is possible to carry out parameter sensitivity analyses, in other words know the influence of parameters on the model, or to optimize the system with respect to a criterion, in other words starting from a given constraint, to find the best parameters or the best combination of parameters to approach the above mentioned constraint as closely and quickly as possible. It is also possible to solve minimum time and minimum energy problems, or to test the consistency of block diagrams. In any case, the software and algorithms already existing and partially integrated into this invention are used, that make use of the formal derivative obtained with this invention.

The invention will be better understood after reading the following description with reference to the appended drawings, wherein:

FIG. 1 shows a block diagram according to the invention;

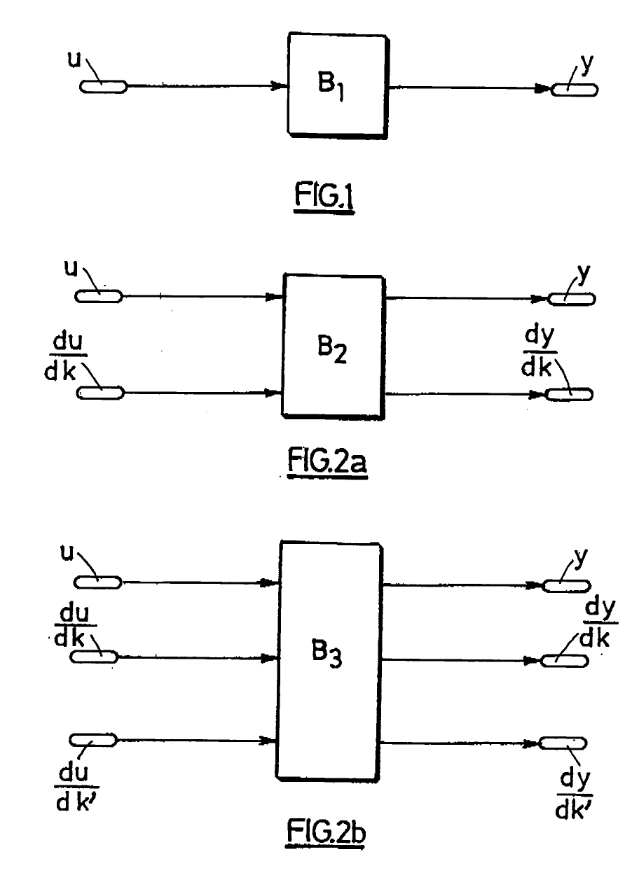

FIG. 2a shows a block diagram differentiated from the block in FIG. 1, with respect to a parameter k;

FIG. 2b shows a block diagram according to the invention, differentiated with respect to two parameters k and k′;

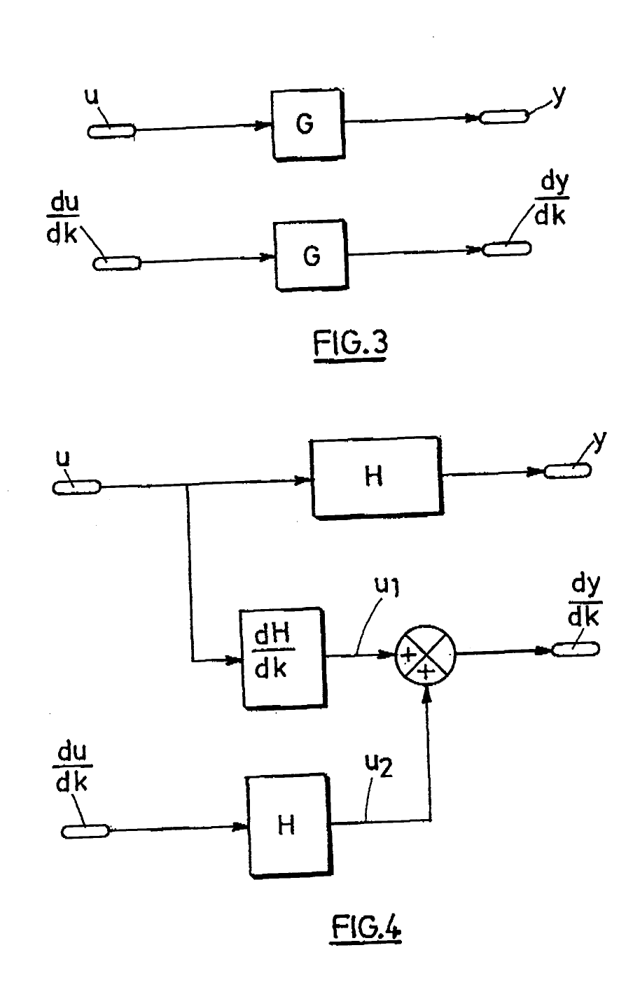

FIG. 3 shows the block diagram differentiated with respect to a parameter k, according to the invention, for a linear block with respect to the input variable u and independent of the parameter k;

FIG. 4 shows the block diagram differentiated with respect to a parameter k, according to the invention, for a linear block with respect to the input variable u;

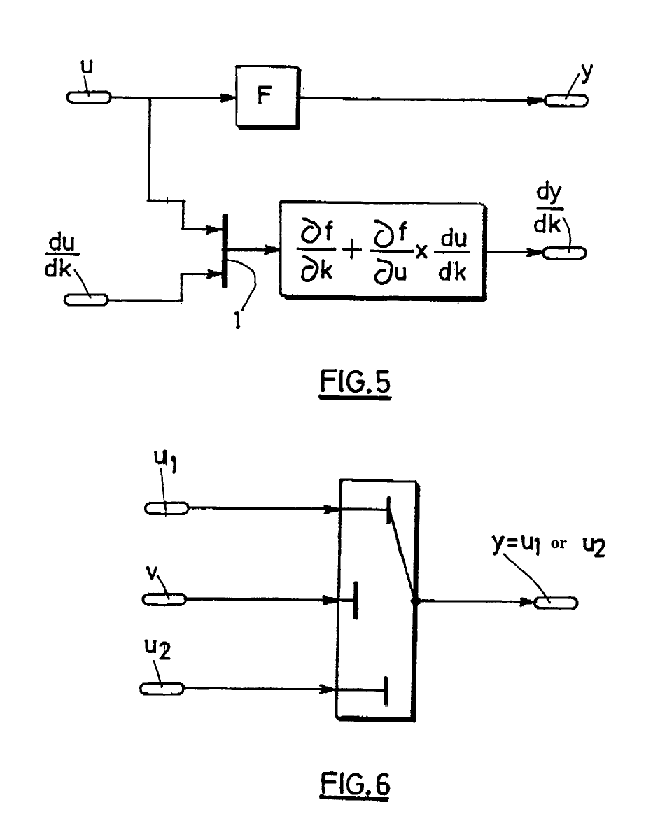

FIG. 5 shows the block diagram differentiated with respect to a parameter k according to the invention, of a block containing a non-linear function with respect to the input variable u and defined analytically;

FIG. 6 shows the block diagram for a switch;

FIG. 7 shows the block diagram differentiated with respect to a parameter k according to the invention, for a switch;

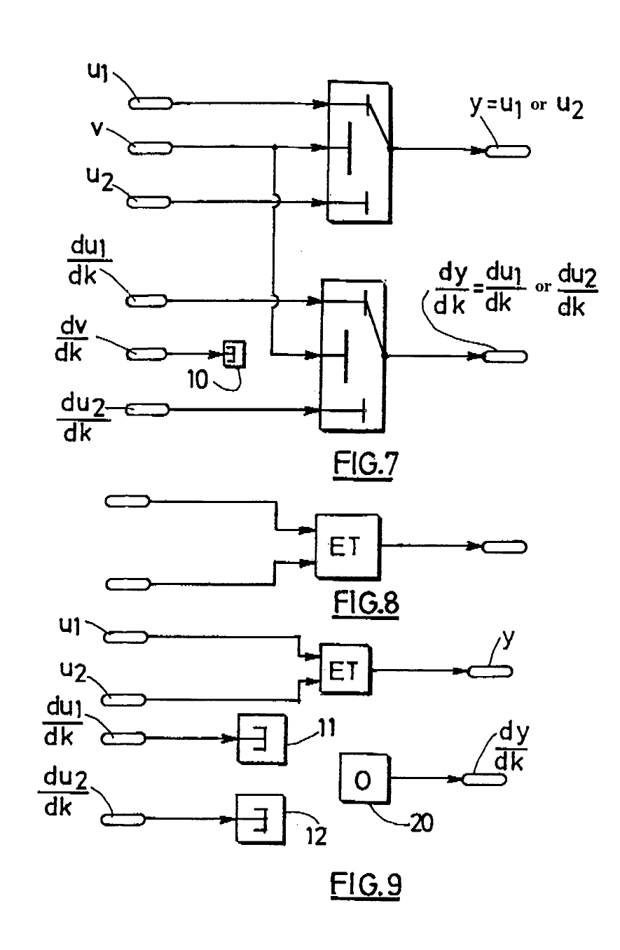

FIG. 8 shows the block diagram for an AND gate;

FIG. 9 shows the block diagram differentiated with respect to a parameter k according to the invention, for an AND gate;

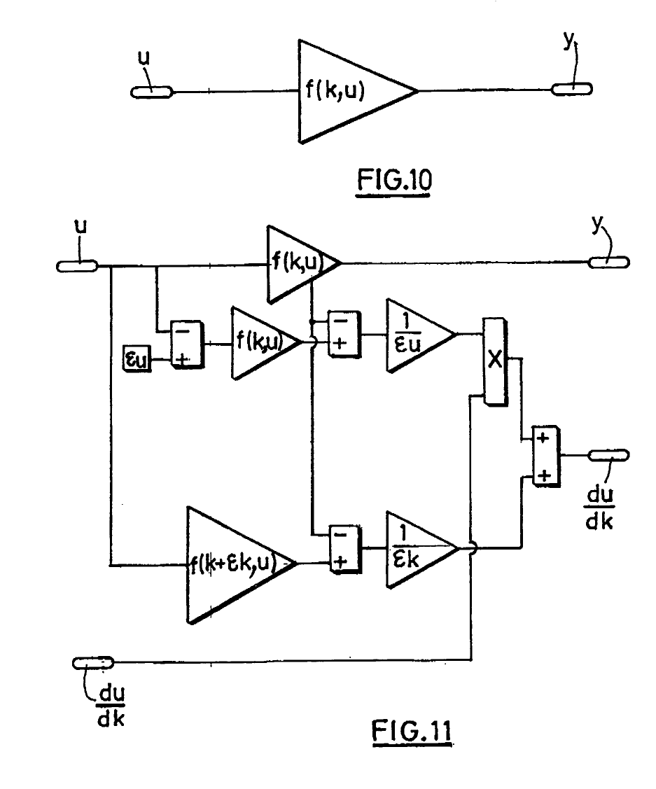

FIG. 10 shows the block diagram for a function for which the equations are not accessible analytically;

FIG. 11 shows the block diagram differentiated with respect to a parameter k according to the invention, for a function for which the equations are not accessible;

FIG. 12 shows the block diagram of a motor position servocontrol system;

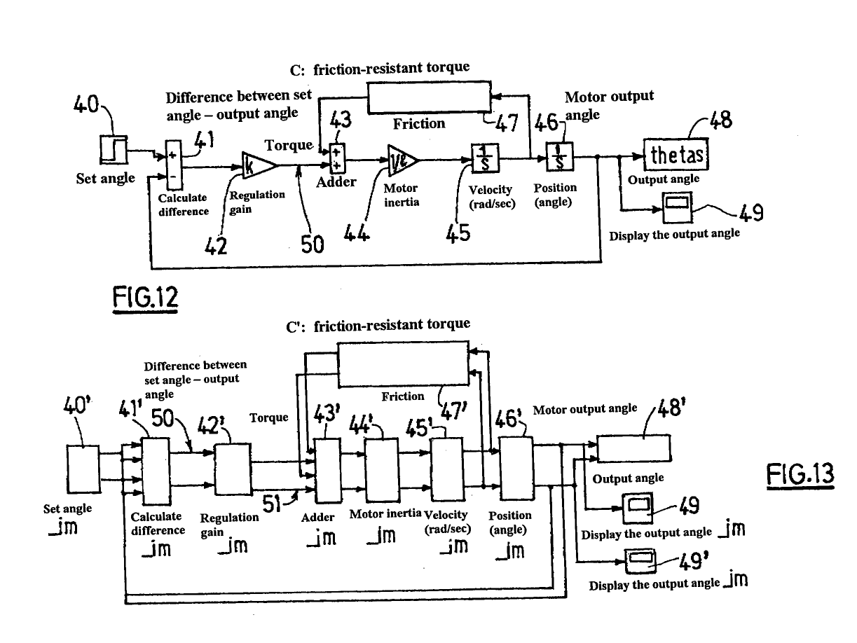

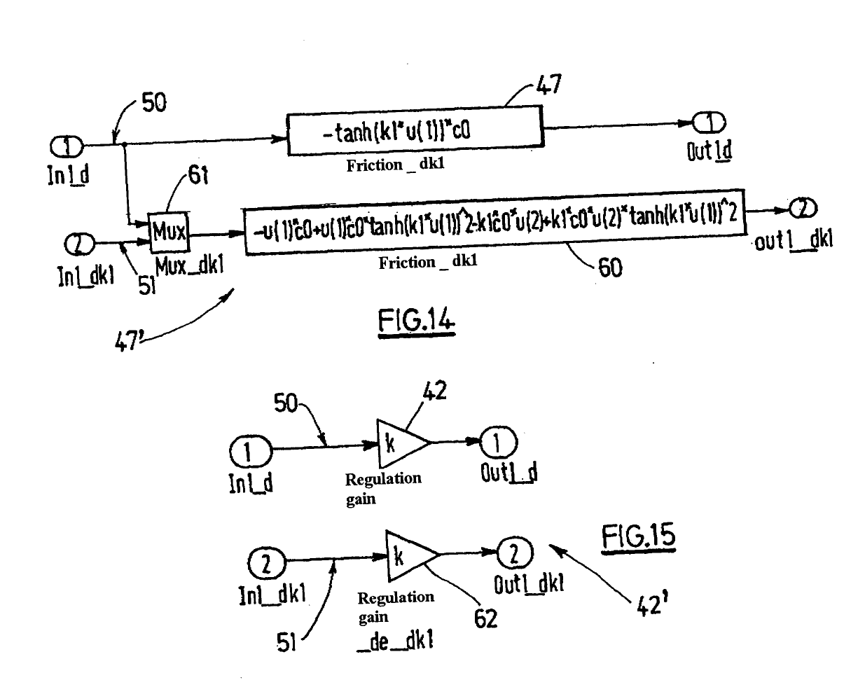

FIG. 13 shows the block diagram differentiated with respect to a parameter k1 according to the invention, of a motor position servocontrol system;

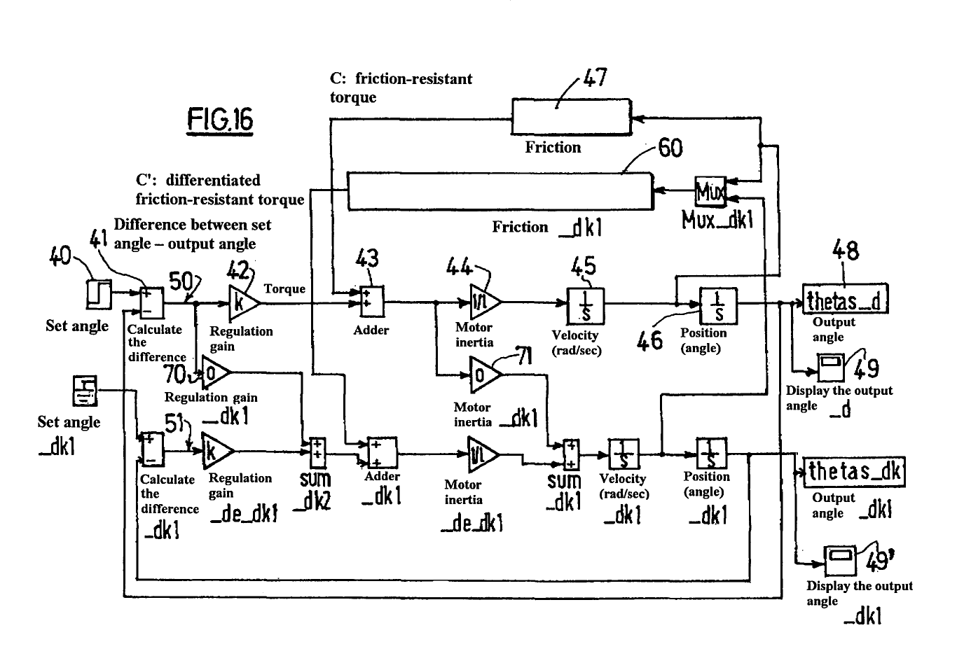

FIG. 14 shows the block diagram differentiated with respect to a parameter k1, according to the invention, for the friction of a motor position servocontrol system;

FIG. 15 shows the block diagram differentiated with respect to a parameter k1 according to the invention, for the gain of a motor position servocontrol system;

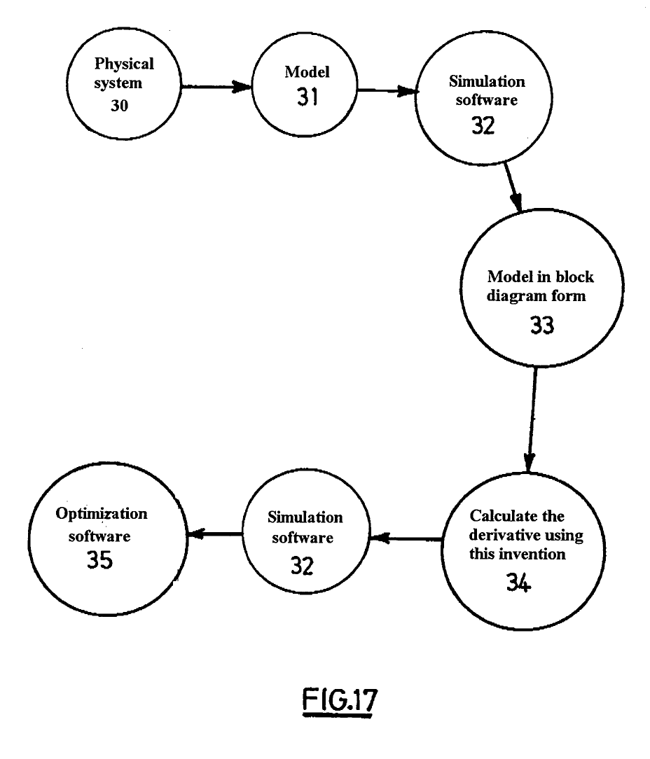

FIG. 16 shows the detailed block diagram differentiated with respect to a parameter k1 according to the invention, for a motor position servocontrol system and

FIG. 17 shows a flow chart for an optimization method according to this invention.

The first step in implementing this invention is to use appropriate simulation software to construct, or build up, the block diagram of the model being studied. With reference to FIG. 1, a block B1 is obtained in a general manner, in which an input variable u is input, and from which an output variable y is output.

Blocks have structural properties. Each block is independent, in other words it does not depend on other blocks around it, and is also self-standing, in other words it only depends on its input variables. This guarantees that all blocks in the block diagram can be differentiated independently of each other.

If f is the function associated with the block, if k is a parameter and u is a variable, its differentiation gives:
dƒ(k,u(k))/dk=ƒ′ₖ(k,u(k))+ƒ′ᵤ₍ₖ₎(k,u(k))*du(k)/dk (1)

In this classical formula ƒ′ₖ(k,u(k)) represents the partial derivative of f with respect to k at the point with coordinates (k,u(k)), this derivative being calculated assuming that u(k) is constant, in other words by fixing u as not depending on k. ƒ′ᵤ₍ₖ₎(k,u(k)) represents the partial derivative of f with respect to u at the point with coordinates (k,u(k)), where k is considered to be fixed.

In application of this relation and due to the fact that blocks in the block diagram can be differentiated independently of each other, to obtain the differentiated diagram for the model with respect to a parameter, the block diagram also contains differentiated variable flows, in other words additional links between blocks transporting derivatives of variables with respect to this parameter in parallel to variable flows, in addition to the variable flows that are transported by links between blocks. For example in this case, in addition to the flow for variable u, its flow differentiated with respect to k, du/dk is added.

From the general rule, eight specific differentiation rules are deduced that will be described below to automate the differentiation mechanism. All these rules are used to differentiate all systems modeled in the form of a block diagram. A distinction is made between six rules on the blocks themselves (rules that will be marked with a M code (M0, M1, M2, . . . )) and two rules on links between the said blocks (rules that will be marked with a J code (J1 and J2)).

The examples demonstrating the rules given below are constructed on isolated blocks. A block diagram containing a plurality of blocks is generalized by applying the property mentioned above, in other words differentiating the blocks independently of each other.

Differentiating a block according to this invention consists of transforming the block into a new subsystem, as a function of rules that will be set down, and systematically inputting the variable flow and its differentiated flow. The flow of output variables is obtained systematically at the output, which has not changed from the flow before the differentiation, since the output variables are obtained by passing the input variables into the initial block which is present in the new subsystem, which contains the initial block and its differentiated structure. We also obtain the differentiated flow of output variables. Thus, when we generalize to a block diagram containing a plurality of blocks, we always have the variable flows and their differentiated flow as input and output of all blocks. These flows can possibly be zero.

In the following, the subsystem derived from the differentiation and that includes the initial block diagram and its differentiated structure, will be called the differentiated block diagram.

With reference to FIG. 2a, the figure shows the general shape of a differentiated block diagram. Starting from a block B1 like that shown in FIG. 1, comprising an input variable u and an output variable y, the block diagram B2 differentiated with respect to parameter k is built up by adding flows of differentiated input variables du/dk and output variables dy/dk in parallel as described above. B2 contains the original block B1 (located between the input u and the output y) and its differentiated structure.

The variable u may be unique. It may be vectorial. Each component of the vector is then a variable. The differentiated flow of the variable becomes a vectorial differentiated flow, in which each component is the differentiated flow of the corresponding variable in the vector of variables.

If the system comprises several parameters, the method is carried out independently in parallel for each parameter. All subsystems corresponding to structures differentiated with respect to each parameter are put in parallel on the diagram. If the example of block B1 in FIG. 1 is used, and in this case it is required to differentiate block B1 with respect to the two parameters k and k′, the result is the block diagram in FIG. 2b. On this block diagram, it can be seen that the flow of the variable u and its flows differentiated with respect to parameters k and k′, namely du/dk and du/dk′ respectively, are put in parallel at the input to the differentiated block diagram B3. B3 contains the original block B1 and the structures of B1 differentiated as a function of k and k′. The flow of the output variable y and its flows differentiated with respect to k and k′, namely dy/dk and dy/dk′ respectively, are obtained at the output.

The differentiated diagram has the same global structure as the initial diagram. The location of the blocks and links between the blocks are the same. The blocks will no longer be the same; they are actually subsystems themselves composed of several blocks. The links no longer contain only variables, but are composed of several links in parallel containing not only the flow of variables, but also their differentiated flows, one for each chosen parameter.

Rules used to differentiate the blocks are described below.

The following correspondences are made in all diagrams illustrating these rules:
k is the parameter with respect to which the model is to be differentiated,
u is the flow of the input variable of the function block,
du/dk is the flow of the input variable u differentiated with respect to k,
y is the flow of the output variable of the function block,
dy/dk is the flow of the output variable y differentiated with respect to k,
H is the block transfer function and
f, F are functions of k and u.

Furthermore, inaccurately but according to conventions used in books when the function contained in a block is linear with respect to the input variable u, in other words when it associates H*u with u, where H does not depend on u, it will be said that the function H, or the block H, is linear with respect to u.

Rule J1: regardless of the block through which the differentiated flow passes, all its outputs will also be affected by the differentiated flow.

In other words, if the differentiated input flow is not zero it will have an influence on the output. The output obtained is the flow of the output variable from the block differentiated with respect to the parameter.

When blocks are connected to each other, the outputs from some that are inputs to others depend on the parameter, if the input originally depended on it, since each block was differentiated successively with respect to the parameter.

Rule J2: every input to a block not affected by the differentiated flow may be considered to be a zero source.

If a block is such that it does not depend on the parameter and its input does not depend on the parameter either, in other words the differentiated input flow is zero, then the differentiated output flow with respect to the parameter is necessarily null.

This is a diagram simplification rule, before the calculations are even started. Thus, working by successive approximation, it is possible to set differentiated flows to null directly until a loop occurs, a block depending on the parameter, an adder, etc., adding a dependence on the parameter. It is thus possible to simplify large parts of the block diagram.

Furthermore, this rules makes it possible to deal with sources (step functions, sinusoidal functions, etc.). If a source does not depend on a parameter, all that is necessary to build up its differentiated flow is to set a null source, that will send a null flow on the link to which it is connected.

Rule M0: to calculate the derivative of a block diagram with respect to its parameters, all inputs of each of its sub-blocks in the original diagram must be accessible at all times during the simulation.

This rule means that access to all variables is necessary if it is required to differentiate the system using the rules that we are describing.

Rule M1:—if a block does not depend on the parameter with respect to which differentiation is required and if none of its inputs transport the flow differentiated with respect to this parameter, then the block no longer appears in the differentiated block diagram.

Thus, all that remains in the differentiated block diagram are the initial block, since the input and output differentiated flows are null (they can be displayed by links transporting a null flow).
with reference to FIG. 3, in the case in which the block does not depend on the parameter but in which the differentiated flow is not null, then the block is copied into the differentiated transmittance if it is linear with respect to the input variable.

Differentiated transmittance means the differentiated structure of the differentiated block diagram.

In other words, if the function block represents a function G that is linear with respect to the input variable u and does not depend on the parameter k with respect to which differentiation is to be done, the differentiated block diagram in FIG. 3 is built up as follows: in input, the input variable u is input into the function block G from which the output variable y is output, while the differentiated value du/dk of the input variable u also is input into the function block G, or a copy of this block, from which the differentiated value dy/dk of the output variable y is output with respect to the parameter k.

Rule M2: the diagram indicated in FIG. 4 is built up for any block that is linear with respect to the input variable, depending on the parameter and for which the differentiated flow is not null.

In other words, if the function block represents a function H that is linear with respect to the input variable u and dependent on the parameter k, a differentiated block diagram like that shown in FIG. 4 is built up comprising a differentiated block representing the derivative dH/dk of the function H with respect to the parameter, the said block comprising the input variable u as input and the output variable u1 of which is added to the variable u2 to obtain the derivative dy/dk of the output variable y from the block diagram with respect to parameter k, the variable u2 being the result of passing the derivative du/dk of the input variable u with respect to parameter k into the function block H or a copy of this function block.

Note that this diagram is built up in application of the differentiation formula (1) described above.

In this case we have y=H*u
The formula gives dƒ(k,u(k))/dk=ƒ′ₖ(k,u(k))+ƒ′ᵤ₍ₖ₎(k,u(k))*du(k)/dk
Therefore in this case we have: dy/dk=u*dH/dk+H*du/dk
And this is what is read on the diagram.

Note that the rule M1 is a simplification of rule M2.

Rule M3: the differentiated block as shown in FIG. 5 is built up for any block that is non linear with respect to the input variable and that is defined analytically.

A function F is defined analytically when a formula describes it. For example, its derivative can be known using formal calculation software.

Thus in FIG. 5, the flows of the variable u and the differentiated variable du/dk are applied to the input of the multiplexer 1, which puts them in the form of a vector. Therefore, these two data flows are available at its output. They are applied to functions that were calculated in the block by connecting this block to a formal calculation software. In other words, due to a formal calculation software, we have calculated the partial derivatives of F with respect to u and k, ∂F/∂u and ∂F/∂k respectively. These values are applied to the variable u, where k is fixed, and ∂F/∂u is multiplied by du/dk, that is available. Thus, the differentiated flow dy/dk=∂F/∂k+∂F/∂u*du/dk.

Rule M4: for a conditional block (switch, hysteresis, etc.) that represents a function defined by parts, the same tests are kept on the original state and the actions are differentiated.

Thus, the condition remains as shown in the original block diagram, while the action performed will be differentiated with respect to the parameter.

In other words, when the function block represents a conditional function, in other words it comprises a control variable controlling at least two variables, a differentiated diagram is built up comprising the same function with input consisting of the same control and the derivatives of variables with respect to the parameter, and output consisting of the output variables differentiated with respect to the parameter, the derivative of the control variable being left unused.

FIG. 6 shows a so-called switch block. Therefore, this block is of the conditional type. It comprises three inputs, u1, u2 and v. The condition applies to the variable v that is a trigger or control signal; the switch is in the up or down position depending on the values of v, and the output obtained is either u1 or u2, which are the variables.

The differentiated block diagram of the switch in FIG. 6 is shown in FIG. 7. According to rule M4, it can be seen that the differentiated structure of the differentiated block is the same switch as that in FIG. 6. The condition also applies to variable v, but this time the values of du1/dk and du2/dk are used as input instead of u1 and u2 respectively. Therefore, for the same conditions, the output obtained is a high or low position, in other words du1/dk or du2/dk respectively. The differentiated flow of v, dv/dk, is put into a sort of ground 10, comparable to an electrical ground, in other words it is not used since conditions are not differentiated.

We could also use the example of an “AND” gate (the logical “and”). As can be seen in FIG. 8, this block is a logical gate that functions with two conditions u1 and u2, functioning on two logical levels, for example 0 and 1. If u1 and u2 are equal to 1, then its output y is equal to 1. Otherwise it is equal to 0. The differentiated structure of such a gate is as given in FIG. 9, according to rule M4. Thus, the differentiated flows du1/dk and du2/dk are sent into the two grounds 11 and 12, while the output dy/dk is always null, output from a null source 20.

Rule M5: when the block equations are not accessible, the block is differentiated locally using the finite differences method on the parameter and its input. It is applied on the same way on blocks containing 1D, 2D, nD interpolation functions.

If the derivative of the block in question cannot be determined graphically, a numerical method is used, in this differentiation by finite difference. The advantage is that this method can be used only on one block, since the differentiation is made independently on each block in the total block diagram. Thus, use of a numerical method can be restricted to blocks for which it is impossible to do otherwise.

In practice, for a function f(k,u) like that shown in FIG. 10, this invention outputs the numerical derivative by calculating finite differences as shown in the diagram in FIG. 11. The user adjusts the increments εᵤ and εₖ as a function of his knowledge of the function. Then, as can be seen, the differentiated structure calculates the following sum:
(f(k,u+εᵤ)+f(k,u))/εᵤ*du/dk+(f(k+εₖ)−f(k,u))/εₖ.

For well-chosen values of εᵤ and εₖ, this formula gives a numerical approximation of:
f′ᵤ₍ₖ₎(k,u(k))*du(k)/dk+f′ₖ(k,u(k))=df(k,u(k))/dk.

Therefore, we actually obtain a numerical approximation of dy/dk at the output.

Therefore using the rules, it is possible to calculate the formal or partly formal derivative of any block diagram.

We can also apply these rules as many times as necessary to obtain second and third derivatives, etc. For example, to obtain the second derivative, all we need to do is to differentiate the differentiated block diagram, by applying the above-mentioned rules. The result is then a new block diagram which is the second differentiated block diagram. An order n derivative is obtained recurrently by differentiating the order n−1 differentiated block diagram.

As an illustration, we will describe an example of differentiation of a model below.

This is a model of a motor slaved in position due to the torque. Position servocontrol is very frequent in all domains in industry in which it is necessary to control or govern mechanisms using motors. For example, cranes, ergonometers, elevators, rocket supports in helicopters, aircraft control surfaces, etc., all use this type of servocontrol. For example, in the case of control surfaces, the control surface must be kept in a certain position, in other words at a certain angle with the horizontal plane, even though it is exposed to pressure forces due to aircraft movements; the servocontrol corrects any movements of the control surface.

The simplified principle is as follows. It is required to servocontrol the angular position of a motor that develops a torque C proportional to the difference between the set value angle θ_{c} and the output angle θₛ:
θ=θ_{c}−θₛ

The load on the motor is composed of an inertia I and a friction-resistant torque C that is constant and has a sign opposite to the sign of the velocity

C=−tan h(k1*θ)*C0 where C0 is the friction amplitude, k1 an empirical parameter and tanh is the representation of the hyperbolic tangent.

The equation of this motor is represented by:
I\ddot{θ}−C0*tan h(k1*\dot{θ})+K*η=0

And at t=0
θ(0)=η₀
\dot{θ}(0)=0

Where θ is the difference θ_{c}−θₛ.

The servocontrol block diagram is illustrated by the graphic interface in FIG. 12. This block diagram comprises a source of the set angle 40, a first adder 41, a first gain 42, a second adder 43, a second gain 44, two dividers 45, 46, a block containing the output angle 48, displayed on a graph 49, a first loop between the output from the second divider 46 and the input to the first adder 41, and a second loop between the output from the first divider 45 and the input of the second divider 43 comprising a function block 47 representing friction, all in series.

The parameters are as follows:
K, gain adjusting the motor speed (motor power),
I, motor inertia,
C0, amplitude of the torque applied by the motor, and
k1, empirically determined value.

We then apply all the above-mentioned rules onto the diagram to obtain the differentiated block diagram, in this case with respect to the parameter k1, in FIG. 13. This diagram shows the same global structure for the differentiated diagram and for the initial diagram. The location of the blocks and the links between them are the same. However, the blocks are no longer the same, they are actually differentiated blocks and the links no longer contain variables 50, but are composed of several links in parallel containing not only the flow of variables 50 but also their flows 51 differentiated with respect to parameter k1. Therefore, in FIG. 13 we have a block 40′ source of the set angle and its flow differentiated with respect to k1, the differentiated block 41′ of the first adder 41, the differentiated block 42′ of the first gain 42, the differentiated block 43′ of the second adder 43, the differentiated block 44′ of the second gain 44, the differentiated blocks 45′, 46′ of the two dividers 45, 46 respectively, a block 48′ containing the output angle and its flow differentiated with respect to parameter k1, these values displayed on graphs 49, 49′, respectively, a first loop between 10 the output from the differentiated block 46′ of the second divider 46 and the input to the differentiated block 41′ of the first adder 41, and a second loop between the output from the differentiated block 45′ of the first divider 45 and the input to the differentiated block 43′ of the second divider 43 containing the differentiated block 47′ of the function block 47 representing friction, all in series.

Dietails of the graphic notations of this diagram are simply the appearance that the designer wants to give to them.

It is worth comparing the diagram in FIG. 12 with the diagram in FIG. 13, and seeing that there is a block (for which the structure cannot be seen) in FIG. 13 corresponding to each block in FIG. 12, and that all links between blocks shown in FIG. 12 are doubled up in FIG. 13, since each variable flow 50 is increased by its differentiated flow 51.

As an example, two differentiated blocks are analyzed so as to illustrate the design of two of the rules described in detail above.

FIG. 14 shows the differentiated block 47′ of the block 47 entitled “friction” in FIG. 12. This block is oriented in the direction opposite to its direction in FIG. 13 for readability reasons, but this is equivalent in that what is important is the relative direction of the arrows with respect to the position of variables and blocks. The presence of the variable flow 50 and the differentiated variable flow 51 with respect to parameter k1 can be seen clearly. This FIG. 14 directly illustrates rule M3, which states that when an analytic function is used, the value dy/dk=∂F/∂k+∂F/∂u*du/dk is calculated. Moreover, there is perfect analogy between FIG. 5 and FIG. 14, in which block 61 represents the multiplexer 1 in FIG. 5. In this case we have F(k1,u(1))=−Co*tan h(k1*u(1)), and du(1)/dk1=u(2), hence the formula obtained in block 60.

FIG. 15 shows the differentiated block diagram 42′ of block 42 representing a gain in FIG. 12. This illustrates rule M1 and in particular FIG. 3, showing the differentiation of a linear block with respect to its input variable, that is not dependent on the parameter but in which the differentiated flow is not null. The variable flow 50 and the variable flow 51 differentiated with respect to parameter k1 are found, together with the presence of two gain blocks 42, 62, corresponding to the same gain.

Many examples could be given, but the complete block diagram differentiated with respect to k1 is shown in FIG. 16, simply as an example application of the rules. Each differentiated subsystem is developed in this figure. It can be seen that this provides access to all differentiated flows 51 of the model. There are the initial blocks 40, 41, 42, 43, 44, 45, 46, 47, 48, 49, and the variable flow 50 and its differentiated flow 51. It shows details of the construction of blocks 40′, 41′, 42′, 43′, 44′, 45′, 46′, 47′, 48′ and 49′, that we will not describe further so as to not unnecessarily complicate the presentation, the description made above being largely sufficient for understanding of FIG. 16. Note simply the presence of blocks 70 and 71, in this case representing the null function, which is not generally true, which connect the variable flow 50 to the differentiated flow 51 in accordance with the needs of differentiation rules.

The same study could be carried out using several parameters, as mentioned above. This increases the number of flows by one each time, and it increases the complexity of subsystems.

Finally, FIG. 17 describes a simplified optimization method according to this invention. The purpose is to optimize a physical system 30. To achieve this, the first step is to create the model 31 of the said physical system 30, that is then simulated in the form of block diagrams using simulation software 32. The passage from a physical system 30 to its model in the form of a block diagram is well known to those skilled in the art. We then calculate the derivatives that we need using this invention 33. This is done with reference to the description given above. The differentiated diagram of the system is obtained in the same simulation software 32. The results are used in optimization software 35. This type of software is well known to those skilled in the art. In particular, it can be used to choose the parameters that have the greatest influence on the system due to a sensitivity study; it can also be used to build a criterion for optimization by means of a sensitivity study of the criterion; finally it can be used for optimization, in other words to choose possible values of parameters to best satisfy the criterion, once the criterion has been established and the parameters have been chosen. In any case, these steps are already known to those skilled in the art, who will be able to include them in the optimization method according to this invention.

1. Method for optimizing at least one parameter (k) characteristic of a physical system that is to be subjected to variable external conditions, in which the system is modeled in the form of a block diagram comprising at least one input variable (u), at least one output variable (y) and at least one function block (B1) between the input variable (u) and output (y) variable, and in which a differentiated block diagram is constructed, from said block diagram (B1), comprising a differentiated block (B2) with the input variable (u) and its derivative with respect to the parameter (du/dk) as input, and the derivative (dy/dk) of the output variable (y) with respect to the parameter (k) as output.

2. Method according to claim 1, in which the differentiated block diagram comprises, as output, the output variable (y) and its derivative (dy/dk) with respect to the parameter (k).

3. Method according to claim 1 in which, the block diagram comprising several function blocks, each differentiated block is constructed independently using the method of claim 1, considering, for each differentiation, the input and output variables of the block being differentiated.

4. Method according to claim 1, in which the input variable (u) and its derivative with respect to the parameter (k) are arranged in vectorial form.

5. Method according to claim 1 in which, the output variable (y) depending on several parameters (k), (k′), a differentiated block diagram is constructed from the block diagram such that when the input variable (u) and its derivatives (du/dk, du/dk′) with respect to each parameter (k), (k′) are input into the new block diagram, the derivatives (dy/dk, dy/dk′) of the output variable (y) with respect to each parameter (k), (k′) are obtained as output.

6. Method according to claim 1 in which, neither the input variable (u) nor the block (B1) depending on the parameter (k), the value of the derivative (dy/dk) of the output variable (y) with respect to the parameter (k) is set equal to zero without calculation.

7. Method according to claim 3, in which, neither the input variable nor the block (B1) depending on the parameter (k), the derivative (dy/dk) of the output variable (y) of each block encountered is set equal to zero until dependence on the parameter (k) is found.

8. Method according to claim 1 in which, the function block (B1) representing a function (G) that is linear with respect to the input variable (u) and does not depend on the parameter (k), the differentiated block diagram is constructed as follows: the input consists of the input variable (u) into the function block (B1) from which the output variable (y) is output, and the derivative (du/dk) of the input variable (u) into the function block (B1), or a copy of this block, from which the derivative (dy/dk) of the output variable (y) with respect to the parameter (k) is output.

9. Method according to claim 1 in which, the function block (B1) representing a function (H) that is linear with respect to the input variable (u) and dependent on the parameter (k), a differentiated block diagram is constructed comprising a differentiated block representing the derivative (dH/dk) of the function (H) with respect to the parameter (k), the input to the said block consisting of the input variable (u) and the output variable (u1) of which is added to the variable (u2) to obtain the derivative (dy/dk) of the output variable (y) from the block diagram with respect to parameter (k), the variable (u2) being the result of passing the derivative (du/dk) of the input variable (u) with respect to parameter (k) into the function block (B1) or a copy of this function block.

10. Method according to claim 1 in which, the function block representing a function (F) that is non linear with respect to the input variable (u) and is defined analytically, a differentiated block diagram is constructed comprising a block representing a function that calculates the sum of the partial derivative (∂F/∂k) of the function (F) with respect to the parameter (k) and the partial derivative (∂F/∂u) of the function (F) with respect to the variable (u), the second of these two partial derivatives being multiplied by the derivative (du/dk) of the variable (u) with respect to parameter (k), the input to the said block consisting of the input variable (u) and its derivative (du/dk) with respect to the parameter (k), and the output being the derivative (dy/dk) of the output variable (y) with respect to parameter (k).

11. Method according to claim 1 in which, the function block (B1) representing a conditional function, in other words comprising a control variable possibly controlling continuous variables, a differentiated diagram is constructed comprising the same function, comprising as input the same control and possibly the derivatives of the variables with respect to the parameter, and as output the output variables differentiated with respect to the parameter (k), the derivative of the control variable being left unused.

12. Method according to claim 1, in which if the function block (B1) is such that its derivative cannot be calculated, then the derivative of the output variable is calculated numerically.

13. Method according to claim 12, in which the derivative of the output variable is calculated using the finite differences method.

14. Optimization method in which the second derivative of an output variable is calculated with respect to a parameter by applying the method according to claim 1 firstly to the block diagram, then secondly to the differentiated block diagram obtained.

15. Optimization method according to claim 1, in which after the differentiated block diagram has been constructed, simulation software and then optimization software is applied to it.

16. Optimization method according to claim 15, in which the same simulation software is applied to the differentiated block diagram and to the system, to model it in the form of a block diagram.

17. System for implementing the method of claim 1, for optimizing a parameter (k1) of a motor servocontrol system according to claim 1, in which, a block diagram of the system comprising a flow of variables consisting of the set angle, a first adder, a first gain, a second adder, a second gain, two dividers, the output angle, displayed on a graph, all in series, a first loop between the output from the second divider and the input to the first adder, and a second loop between the output from the first divider and the input to the second divider comprising a function block representing friction, a differentiated block diagram is constructed comprising a variables flow and its flow differentiated with respect to parameter (k1), in series, with a block consisting of the set angle and its flow differentiated with respect to parameter (k1), the differentiated block of the first adder, the differentiated block of the first gain, the differentiated block of the second adder, the differentiated block of the second gain, the differentiated blocks of the two dividers, respectively, the differentiated block of the output angle, containing the output angle and its flow differentiated with respect to parameter (k1), these values displayed on graphs, respectively, a first loop between the output from the differentiated block of the second divider and the input to the differentiated block of the first adder, and a second loop between the output from the differentiated block of the first divider and the input to the differentiated block of the second divider containing the differentiated block of the function block representing friction.

18. System for implementing the method of claim 1, in which a differentiated block diagram is constructed from a block diagram containing a flow of variables and blocks, the differentiated block diagram containing the above mentioned blocks and blocks linking the flow of variables and its differentiated flow.
